(19) United States
(12) Patent Application Publication
(10) Pub. No.: US 2008/0143663 A1
(43) Pub. Date: Jun. 19, 2008

(54) Liquid crystal display panel and an active array substrate thereof

(75) Inventor: Ching-Yi Wang, Hsin-Chu (TW)

Correspondence Address: BACON & THOMAS, PLLC, 625 SLATERS LANE, FOURTH FLOOR, ALEXANDRIA, VA, 22314, US

(73) Assignee: AU Optronics Corp., Hsinchu (TW)

(21) Appl. No.: 11/812,403

(22) Filed: Jun. 19, 2007

(30) Foreign Application Priority Data
Dec. 15, 2006 (TW) 095147089

(51) Int. Cl. G09G 3/36

(52) U.S. Cl. 345/92

(57) ABSTRACT

A liquid crystal display panel and an active array substrate thereof are disclosed. The projected area of the pixel electrodes in each display sub-region is reduced gradually to decrease the parasitic capacitance, the liquid crystal capacitance, and/or the storage capacitance. Therefore, the total capacitance value of each pixel is decreased gradually also. The feed through voltage ΔVp is compensated by the capacitance to make the feed through voltage ΔVp around the liquid crystal display panel approach unity to improve the display quality.

### BACKGROUND OF THE INVENTION

a. Field of the Invention

The present invention relates to a liquid crystal display panel and an active array substrate thereof and, more particularly, to a thin film transistor-liquid crystal display panel and an active array substrate thereof.

b. Description of Related Art

With reference to FIGS. 1A and 1B, FIG. 1A shows a top view of a pixel of a conventional thin film transistor-liquid crystal display (TFT-LCD) panel, and FIGS. 1B and 1C show cross-section views of the upper substrate and the lower substrate along the line I-I in FIG. 1A, respectively.

Referring to FIG. 1C which shows a conventional active array substrate is manufactured by the following process: first, gate lines 31 (shown in FIG. 1A) and storage capacitor lines 32 are formed on the lower substrate 20; subsequently, an insulating layer 34 is formed, and then source lines 33, an organic layer 36 and pixel electrodes 35 are formed in sequence; and finally, an alignment film 37 is formed.

A conventional TFT-LCD panel further comprises an upper substrate 21 above the lower substrate 20 to form a space. Referring to the cross-section view of the upper substrate 21 shown in FIG. 1B, which corresponds to the lower substrate 20 shown in FIG. 1C. First, a color filter layer 40 and a common electrode 39 are formed in sequence on the upper substrate 21 to form an upper substrate 21. Subsequently, the lower substrate and the upper substrate are assembled to form a space. Finally, the space is filled with a liquid crystal layer 38 to achieve a TFT-LCD panel.

In a conventional TFT-LCD panel, the region of the pixel 3 is defined by forming the gate line 31 and the source line 33, and the pixel electrode 35 is formed in the pixel 3. The equivalent circuit of the pixel 3 is made up of a thin film transistor 30, a liquid crystal capacitance (Clc), and a storage capacitance (Cs). The pixel 3 electrically connects to a gate driver chip (such as IC, not shown) by the gate 302 of the thin film transistor 30 and the gate line 31, and electrically connects to a source driver chip (such as IC, not shown) by the source 301 of the thin film transistor 30 and the source line 33. The drain 303 of the thin film transistor 30 electrically connects to the pixel electrode 35 and the storage capacitor line 32.

The thin film transistor 30 is as a switch to control the voltage applied on the pixel electrode 35, the liquid crystal capacitance (Clc) between the pixel electrode 35 and the common electrode 39 thereon in a conductor-insulator-conductor structure, and the storage capacitance (Cs) between the storage capacitor line 32 and the pixel electrode 35 thereon.

When the gate 302 of the thin film transistor 30 is driven by the gate driver chip through the gate line 31, leads the voltage signal from the source driver chip can be transmitted to the source 301 of the thin film transistor 30 through the source line 33 and then to the liquid crystal capacitance (Clc) and the storage capacitance (Cs) through the drain 303, and the received voltage signal is stored by the liquid crystal capacitance (Clc) and the storage capacitance (Cs).

According to an electronic formula, it is known that the capacitance value is positively related to the projected area of the conductor-insulator-conductor structure inducing the formation of the capacitance. Thereby, the liquid crystal capacitance (Clc) is positively related to the projected area of the pixel electrode 35 overlapping that of the common electrode 39. Similarly, the storage capacitance (Cs) is positively related to the projected area of the pixel electrode 35 overlapping that of the storage capacitor line 32.

However, parasitic capacitance, such as gate/source capacitance (Cgd) and source/drain capacitance (Csd), also exists in a conventional TFT-LCD panel. The gate/source capacitance (Cgd) is induced by the projected area of the pixel electrode 35 overlapping that of the gate line 31, and the source/drain capacitance is induced by the projected area of the pixel electrode 35 overlapping that of the source line 33. In the specification, the sum of the parasitic capacitance, the liquid crystal capacitance (Clc), and the storage capacitance (Cs) is the total capacitance C (C=Cgd+Csd+Clc+Cs).

Referring to the voltage waveform of a conventional pixel shown in FIG. 2 wherein the horizontal axis represents time, the vertical axis represents voltage, the waveform 41 represents the voltage waveform applied on the gate line, the waveform 42 represents the voltage waveform applied on the source line, and the waveform 43 represents the voltage waveform applied on the pixel electrode.

As shown in FIG. 2, when the voltage applied on the gate line rises to Vgh by the gate driver chip, the source driver chip starts to raise the voltage on the source line to charge the pixel electrode. When the voltage applied on the pixel electrode rises to the predetermined voltage value, the voltage on the gate line decreases to Vgl. The decrease of the voltage on the gate line induces a coupling effect on the pixel electrode to cause the decrease of the voltage on the pixel electrode ΔVp (feed through voltage). The relation formula about gate/drain capacitance (Cgd), source/drain capacitance (Csd), liquid crystal capacitance (Clc), storage capacitance (Cs), high voltage on the gate line (Vgh) and low voltage on the gate line (Vgl) is shown as follows:

ΔVp=(Cgd/(Cgd+Csd+Clc+Cs))−(Vgh−Vgl), or

ΔVp=(Cgd/C)−(Vgh−Vgl).

In general, the gate line electrically connects to different pixels and the distance between the gate driver chip and a pixel is different from that between the gate driver chip and another pixel. When the voltage on the gate line rises to Vgh by the gate driver chip, the Vgh signal from the gate driver chip varies with the distance between the pixel and the gate driver chip, and the observed Vgh on the gate line of the first pixel near the gate driver chip (represented as Vghl) is different from that of the last pixel away from the gate driver chip (represented as Vghf). Thereby, the RC time delay induced by the various total capacitance values and the resistance value of the gate line causes a voltage drop ΔVg between the Vghl and Vghf (ΔVg=Vghl−Vghf).

According to the above, it is known that Vgh of each pixel connecting to the gate line is affected by the different RC time delay. The larger the distance between the pixel and the gate driver chip, the larger the effect of RC time delay, lower Vgh, and smaller feed through voltage ΔVp.

The disunity of feed through voltage ΔVp causes the unbalance of polarity reverse of the pixel electrode which in turn leads to error of the gray level voltage reference. Thereby, the observed flicker reduces the display quality of a liquid crystal display panel.

### SUMMARY OF THE INVENTION

It is one object of the present invention to provide a liquid crystal display panel and an active array substrate so as to gradually reduce the total capacitance value of each pixel and perform capacitor compensation for the feed through voltage ΔVp.

It is another object of the present invention to provide a liquid crystal display panel and an active array substrate so as to inhibit the flicker and improve the display quality of a liquid crystal display panel.

To accomplish the above-mentioned objects, the present invention provides a liquid crystal display panel, comprising: a lower substrate, comprising: a plurality of display sub-regions, each of the display sub-region comprising a plurality of pixels, each of the pixel comprising a thin film transistor and a pixel electrode electrically connected to the thin film transistor, and the thin film transistor adapted to control a voltage of the pixel electrode; a plurality of gate lines, each gate line electrically connected to the thin film transistor of each pixel; and a plurality of source lines, each source line electrically connected to the thin film transistor of each pixel; an upper substrate disposed above the lower substrate to form a space; and a liquid crystal layer is disposed in the space, wherein the projected area of the pixel electrode, the projected area of the gate line, and the projected area of the source line partially overlaps each other in each pixel, the projected areas of the pixel electrodes in the same display sub-region of the lower substrate are substantially identical, and the projected areas of the pixel electrodes in the different display sub-regions are reduced gradually along one direction.

To accomplish the above-mentioned objects, the present invention provides an active array substrate incorporated in a liquid crystal display panel, comprising: a plurality of display sub-regions, each of the display sub-regions comprising a plurality of pixels, each of the pixels comprising a thin film transistor and a pixel electrode electrically connected to the thin film transistor, and the thin film transistor adapted to control a voltage of the pixel electrode; a plurality of gate lines, each gate line electrically connected to the thin film transistor of each pixel; and a plurality of source lines, each source line electrically connected to the thin film transistor of each pixel, wherein the projected area of the pixel electrode, the projected area of the gate line, and the projected area of the source line partially overlaps each other in each pixel, the projected areas of the pixel electrodes in the same display sub-region of the lower substrate are substantially identical, and the projected areas of the pixel electrodes in the different display sub-regions are reduced gradually along one direction.

The included angle between the gate line and the source line of the present invention is not limited. Preferably, the source line is substantially vertical to the gate line.

In one embodiment of the present invention, the projected areas of the pixel electrodes in the different display sub-regions are reduced gradually along the direction of the gate lines. In another embodiment of the present invention, the projected areas of the pixel electrodes in the different display sub-regions are reduced gradually along the direction of the source lines.

In one embodiment of the present invention, the projected areas of the pixel electrodes overlaps the projected areas of the source lines in the same display sub-region are substantially identical, and the projected areas of the pixel electrodes overlaps the projected areas of the source lines in the different display sub-regions are reduced gradually.

In another embodiment of the present invention, the projected areas of the pixel electrodes overlaps the projected areas of the gate lines in the same display sub-region are substantially identical, and the projected areas of the pixel electrodes overlap the projected areas of the gate lines in the different display sub-regions are reduced gradually.

In addition, the lower substrate of the present invention can further comprise a plurality of storage capacitor lines formed on the lower substrate, the storage capacitor lines disposed below the pixel electrodes. The projected areas of the pixel electrodes partially overlap the projected areas of the storage capacitor lines. The projected areas of the pixel electrodes overlaps the projected areas of the storage capacitor lines in the same display sub-region are substantially identical, and the projected areas of the pixel electrodes overlaps the projected areas of the storage capacitor lines in the different display sub-regions are reduced gradually.

Furthermore, the upper substrate of the present invention can further comprise a common electrode located above the liquid crystal layer. The projected areas of the pixel electrodes partially overlap the projected areas of the common electrode. The projected areas of the pixel electrodes overlap the projected areas of the common electrode in the same display sub-region are substantially identical, and the projected areas of the pixel electrodes overlaps the projected areas of the common electrode in the different display sub-regions are reduced gradually.

The outlines of the display sub-regions of the present invention are not limited. In one embodiment of the present invention, the boundary between the display sub-regions is substantially vertical to the gate lines. In another embodiment of the present invention, the boundary between the display sub-regions is substantially vertical to the source lines. Furthermore, in another embodiment of the present invention, the projected areas of the display sub-regions are substantially identical.

In addition, the number of the display sub-regions of the present invention is not limited.

### BRIEF DESCRIPTION OF THE DRAWINGS

FIG. 1A is a top-view of a conventional pixel;

FIG. 1B is a cross-section view of a conventional upper substrate;

FIG. 1C is a cross-section view of a conventional lower substrate;

FIG. 2 is a diagram of a voltage waveform of a conventional pixel;

FIG. 3 is a top-view of display sub-regions of one embodiment of the present invention;

FIGS. 4A, 4B, and 4C are top-views of pixels in display sub-regions of another embodiment of the present invention;

FIGS. 5A, 5B, and 5C are top-views of pixels in display sub-regions of further embodiment of the present invention; and

FIG. 6 is a top-view of display sub-regions of another embodiment of the present invention.

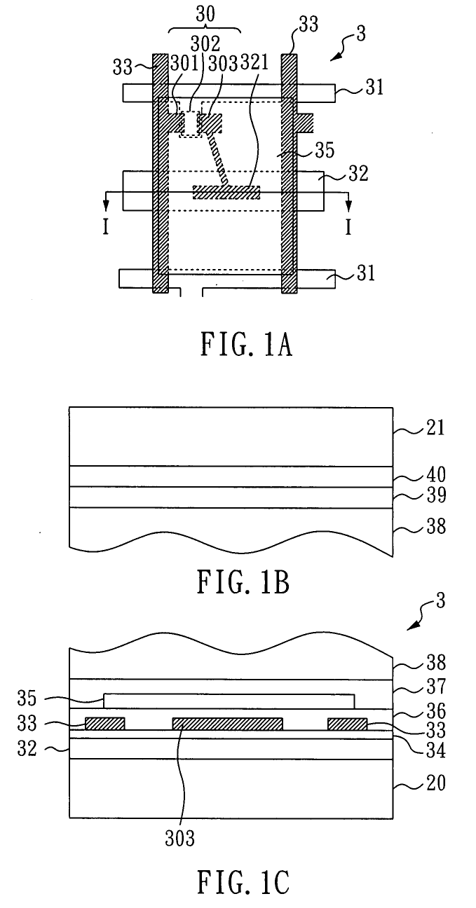

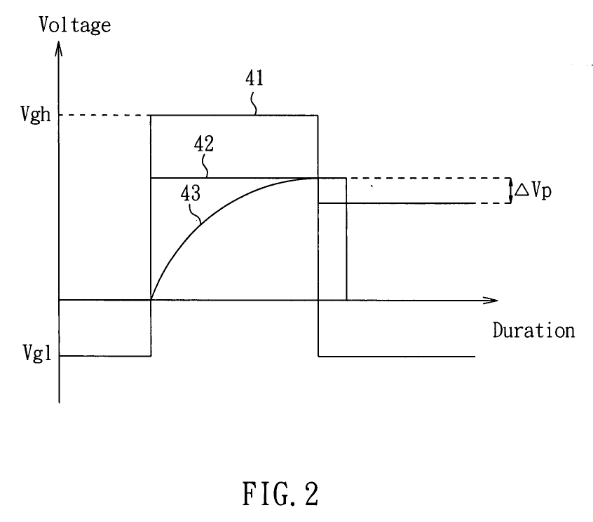

### DETAILED DESCRIPTION OF THE PREFERRED EMBODIMENT

### Embodiment 1

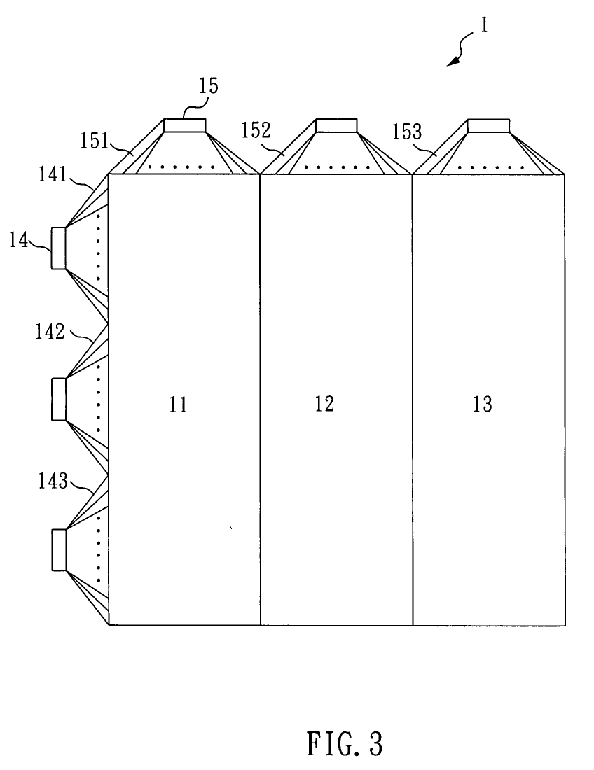

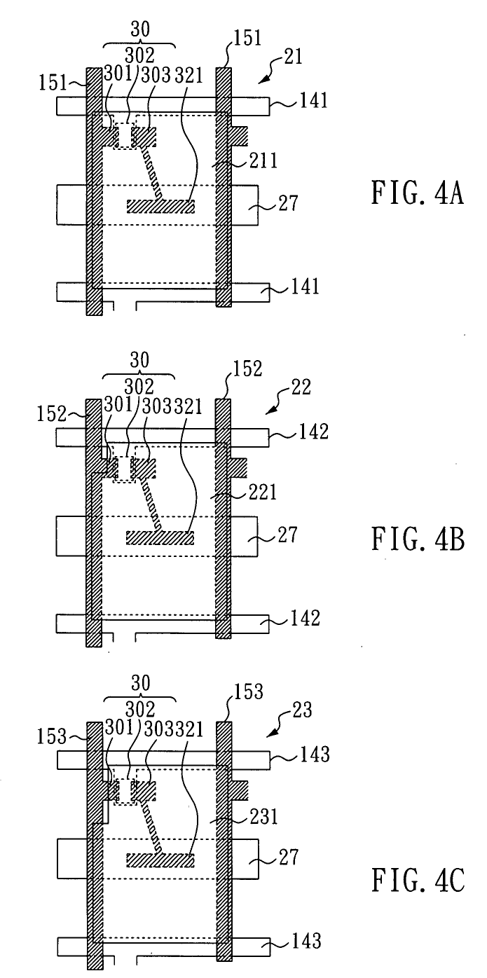

With reference to FIGS. 3, 4A, 4B, and 4C, FIG. 3 is a top-view of the display sub-regions, and FIGS. 4A to 4C are top-views of the pixels in the display sub-regions of the present invention.

The lower substrate (not shown) of the liquid crystal display panel 1 is defined into the display sub-regions 11, 12, and 13. Each of the three display sub-regions 11, 12, and 13 comprises plural pixels 21, 22, or 23; plural gate driver circuits 14 (such as chip, IC, or likes); and plural source driver circuits 15 (such as chip, IC, or likes). In addition, the projected areas of the display sub-regions 11, 12, and 13 are substantially identical.

Each of the pixels 21, 22, and 23 comprises a thin film transistor 30; and a pixel electrode 211, 221, and 231, respectively. The thin film transistor 30 comprises a source 301, a gate 302, and a drain 303. Each of the pixels 21, 22, and 23 electrically connect to the gate driver circuit 14 through the gate 302 and the gate line 141, 142, and 143. Each of the pixels 21, 22, and 23 electrically connects to the source driver circuit 15 through the source 301 and the source line 151, 152, and 153, respectively. The electrical state of the storage capacitor electrode 321 is substantially equal to that of the drain 303.

In the present embodiment, the boundaries among the display sub-regions 11, 12, and 13 are substantially vertical to the gate lines 141, 142, and 143 so as to perform compensation for the voltage signal of the gate lines 141, 142, and 143. The number of the display sub-regions is not limited and can be any integer. In FIG. 3, the gate lines are arranged horizontally, and the display sub-regions 11, 12, and 13 are arranged horizontally and sequentially. However, in another embodiment, the number of the display sub-regions can be another integer, and the gate lines can be arranged along another direction.

As shown in FIG. 4A, the pixel electrode 211 of the pixel 21 in the display sub-region 11 is designed as a conventional one. The projected area of the pixel electrode 211 is the same as a conventional one, and the projected area of the pixel electrode 211 overlaps the projected area of the gate lines 141 and the source lines 151. Thereby, the total capacitance value of the pixel 21 is the same as a conventional one. In other words, the feed through voltage ΔVp of the pixel 21 is the same as a conventional one.

In FIG. 4B, the projected area of the pixel electrode 221 of the pixel 22 in the display sub-region 12 is reduced so as to reduce source/drain capacitance (Csd) and liquid crystal capacitance (Clc) of the pixel 22. Thereby the total capacitance C of the pixel 22 is reduced, and the feed through voltage ΔVp of the pixel 22 is substantially larger than that of the pixel 21.

In FIG. 4C, in comparison with the pixel 22 in FIG. 4B, the projected area of the pixel electrode 231 of the pixel 23 in the display sub-region 13 is further reduced so as to further reduce the total capacitance C of the pixel 23 and further increase the feed through voltage ΔVp of the pixel 23.

According to the above process, the projected areas of the pixel electrodes 211, 221, and 231 of the pixels 21, 22, and 23 in the display sub-regions 11, 12, and 13 are reduced gradually along one direction. Thereby, the capacitor compensation of the pixels 21, 22, and 23 in the display sub-regions 11, 12, and 13 is reduced gradually so as to make the feed through voltage ΔVp of the pixels 11, 12, and 13 in the display sub-regions 11, 12, and 13 of the liquid crystal display panel 1 approach unity.

In the present embodiment, the projected area of the pixel electrodes 221 and 231 of the pixels 22 and 23 overlapping the projected area of the source lines 152 and 153 are reduced, respectively. Thereby, in addition to reducing the liquid crystal capacitance (Clc), the source/drain capacitance (Csd) of the pixels 22 and 23 is also reduced so as to obviously reduce the total capacitance values C of the pixels 22 and 23 and to increase the feed through voltage ΔVp of the pixels 22 and 23. However, in another embodiment, the reduced projected areas of the pixel electrodes 221 and 231 of the pixels 22 and 23, respectively, are not limited to the projected areas of the pixel electrodes overlapping the projected area of the source lines 152 and 153.

Furthermore, in the present embodiment, the projected areas of the pixel electrodes 211, 221, and 231 of the pixels 21, 22, and 23 are reduced along the direction of the arrangement of the display sub-regions 11, 12, and 13 according to the gate driver circuits 14. However, in another embodiment, the projected areas of the display sub-regions 11, 12, and 13 can be reduced along another direction.

In another embodiment of the present invention, the reduced projected areas of the pixel electrodes in the different display sub-regions also can be the projected areas of the pixel electrodes overlapping the projected area of the gate lines, and the projected areas of the pixel electrodes overlapping the projected area of the gate lines in the same display sub-region are substantially identical. Accordingly, in addition to the liquid crystal capacitance (Clc), the gate/drain capacitance (Cgd) of the different display sub-regions is also reduced gradually to reduce gradually the total capacitance values of the different display sub-regions.

In another embodiment of the present invention, the reduced projected areas of the pixel electrodes in the different display sub-regions also can be the projected areas of the pixel electrodes overlapping the projected area of the common electrode (not shown) of the upper substrate (not shown), and the projected areas of the pixel electrodes overlapping the projected area of the common electrode in the same display sub-region are the same. Accordingly, the liquid crystal capacitance (Clc) of the different display sub-regions is reduced gradually to reduce gradually the total capacitance values of the different display sub-regions.

### Embodiment 2

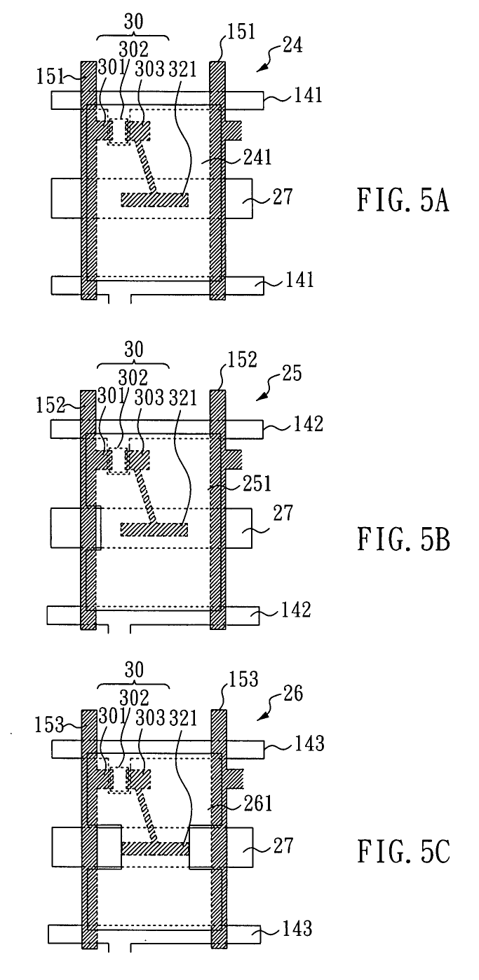

With reference to FIGS. 3, 5A, 5B, and 5C, FIGS. 5A to 5C are top-views of the pixels in the display sub-regions of the present embodiment. In the present embodiment, each of the display sub-regions 11, 12, and 13 comprises plural pixels 24 (as shown in FIG. 5A), 25 (as shown in FIG. 5B), or 26 (as shown in FIG. 5C).

As shown in FIG. 5A, the pixel 24 in the display sub-region 11 is designed as a conventional one. The projected area of the pixel electrode 241 of the pixel 24 is the same as a conventional one. Thereby, the total capacitance value of the pixel 24 is the same as a conventional one. In other words, the feed through voltage ΔVp of the pixel 24 is the same as a conventional one.

In FIG. 5B, the projected area of the pixel electrode 251 of the pixel 25 overlapping the projected area of the source lines 152 in the display sub-region 12 is reduced so as to reduce source/drain capacitance (Csd) and liquid crystal capacitance (Clc) of the pixel 25. Thereby, in comparison with the pixel 24, the total capacitance C of the pixel 25 is reduced, and the feed through voltage ΔVp of the pixel 25 is increased.

In FIG. 5C, in comparison with the pixel 25 in FIG. 5B, the projected area of the pixel electrode 261 of the pixel 26 in the display sub-region 13 is further reduced, and the reduced projected area of the pixel electrode 261 is the projected area of the pixel electrode 261 overlapping the projected area of the storage capacitor line 27. Thereby, in addition to the source/drain capacitance (Csd) and the liquid crystal capacitance (Clc) of the pixel 26, the storage capacitance (Cs) of the pixel 26 can be further reduced so as to make the total capacitance value of the pixel 26 substantially less than that of the pixel 25 and further compensate for the feed through voltage ΔVp of the pixel 26. As a result, the feed through voltage ΔVp of the pixels 24, 25, and 26 of the liquid crystal display panel 1 approach unity.

### Embodiment 3

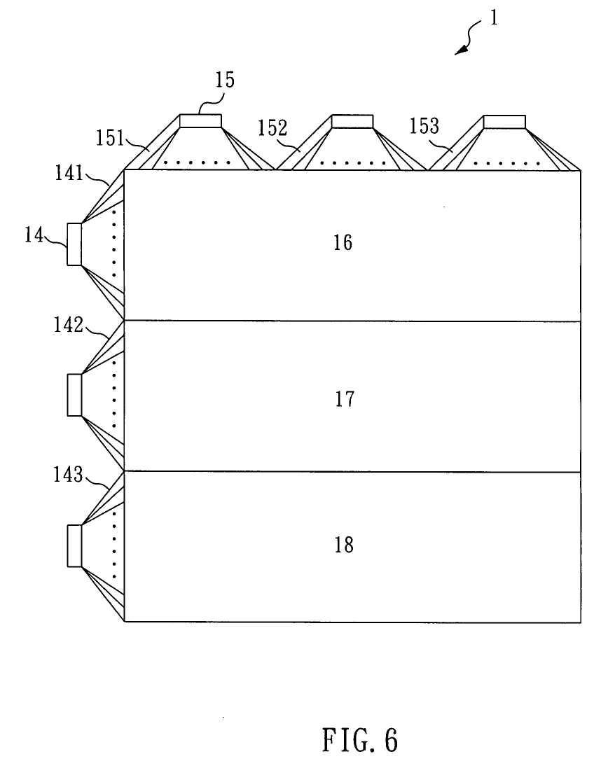

With reference to FIGS. 6, 4A, 4B, and 4C, FIG. 6 is a top-view of the display sub-regions, and the pixels 21, 22, and 23 (shown in FIGS. 4A to 4C) are applied in the display sub-regions 16, 17, and 18 (shown in FIG. 6), respectively.

In the present embodiment, the boundaries among the display sub-regions 16, 17, and 18 are substantially vertical to the source lines 151, 152, and 153 so as to perform compensation for the voltage signal of the source lines 151, 152, and 153. As shown in FIG. 6, the source lines 151, 152, and 153 are arranged vertically, and thereby the display sub-regions 16, 17, and 18 are arranged vertically.

In the present embodiment, the projected areas of the pixel electrodes 211, 221, and 231 of the pixels 21, 22, and 23 in the display sub-regions 16, 17, and 18, overlapping those of the source lines 151, 152, and 153, are reduced gradually so as to reduce gradually the total capacitance values C of the pixels 21, 22, and 23 along one direction to perform capacitor compensation for the feed through voltage ΔVp. As a result, the feed through voltage ΔVp of the pixels 21, 22, and 23 of the liquid crystal display panel 1 approach unity.

### Embodiment 4

In the present embodiment, the pixels 24, 25, and 26 (shown in FIGS. 5A to 5C) are applied in the display sub-regions 16, 17, and 18 (shown in FIG. 6), respectively. In other words, the pixel 24 shown in FIG. 5A is applied in the display sub-region 16, the pixel 25 shown in FIG. 5B is applied in the display sub-region 17, and the pixel 26 shown in FIG. 5C is applied in the display sub-region 18. As a result, the total capacitance values C of the pixels 24, 25, and 26 are reduced gradually along one direction to make the feed through voltage ΔVp of the pixels 24, 25, and 26 approach unity.

Accordingly, the present invention reduces the parasitic capacitance, the liquid crystal capacitance, and/or the storage capacitance between the pixel electrodes and the signal lines by reducing gradually the projected areas of the pixel electrodes overlapping the projected areas of the signal lines in the display sub-regions so as to reduce gradually the total capacitance values of the pixels and perform capacitor compensation for the feed through voltage ΔVp. As a result, the feed through voltage ΔVp of the pixels approaches unity so as to inhibit the flicker and improve the display quality of the liquid crystal display panel.

Although the present invention has been explained in relation to its preferred embodiment, it is to be understood that many other possible modifications and variations can be made without departing from the spirit and scope of the invention as hereinafter claimed.

What is claimed is:

1. A liquid crystal display panel, comprising:
a lower substrate, comprising:
a plurality of display sub-regions, each of the display sub-regions comprising a plurality of pixels, each of the pixels comprising a thin film transistor and a pixel electrode electrically connected to the thin film transistor, and the thin film transistor adapted to control a voltage of the pixel electrode;
a plurality of gate lines, each gate line electrically connected to the thin film transistor of each pixel; and
a plurality of source lines, each source line electrically connected to the thin film transistor of each pixel;
an upper substrate disposed above the lower substrate to form a space; and
a liquid crystal layer disposed in the space,
wherein the projected area of the pixel electrode, the projected area of the gate line, and the projected area of the source line partially overlaps each other in each pixel, the projected areas of the pixel electrodes in the same display sub-region of the lower substrate are substantially identical, and the projected areas of the pixel electrodes in the different display sub-regions are reduced gradually along one direction.

2. The panel of claim 1, wherein the projected areas of the pixel electrodes in the different display sub-regions are reduced gradually along the direction of the gate lines.

3. The panel of claim 1, wherein the projected areas of the pixel electrodes in the different display sub-regions are reduced gradually along the direction of the source lines.

4. The panel of claim 1, wherein the projected areas of the pixel electrodes overlaps the projected areas of the source lines in the same display sub-region are substantially identical, and the projected areas of the pixel electrodes overlaps the projected areas of the source lines in the different display sub-regions are reduced gradually.

5. The panel of claim 1, wherein the projected areas of the pixel electrodes overlaps the projected areas of the gate lines in the same display sub-region are substantially identical, and the projected areas of the pixel electrodes overlaps the projected areas of the gate lines in the different display sub-regions are reduced gradually.

6. The panel of claim 1, further comprising a plurality of storage capacitor lines formed on the lower substrate, the storage capacitor lines are disposed below the pixel electrodes, the projected areas of the pixel electrodes partially overlap the projected areas of the storage capacitor lines, the projected areas of the pixel electrodes overlapping the projected areas of the storage capacitor lines in the same display sub-region are substantially identical, and the projected areas of the pixel electrodes overlapping the projected areas of the storage capacitor lines in the different display sub-regions are reduced gradually.

7. The panel of claim 1, further comprising a common electrode formed on the upper substrate, the common electrode located above the liquid crystal layer, the projected areas of the pixel electrodes partially overlap the projected areas of the common electrode, the projected areas of the pixel electrodes overlap the projected areas of the common electrode in the same display sub-region are substantially identical, and the projected areas of the pixel electrodes overlap the projected areas of the common electrode in the different display sub-regions are reduced gradually.

8. The panel of claim 1, wherein the boundary between the display sub-regions is substantially vertical to the gate lines.

9. The panel of claim 1, wherein the boundary between the display sub-regions is substantially vertical to the source lines.

10. The panel of claim 1, wherein the projected areas of the display sub-regions are substantially identical.

11. An active array substrate incorporated in a liquid crystal display panel, comprising:
a plurality of display sub-regions, each of the display sub-regions comprising a plural of pixels, each of the pixels comprising a thin film transistor and a pixel electrode electrically connected to the thin film transistor, and the thin film transistor adapted to control a voltage of the pixel electrode;
a plurality of gate lines, each gate line electrically connected to the thin film transistors of each pixel; and
a plurality of source lines, each source line electrically connected to the thin film transistors of each pixel,
wherein the projected area of the pixel electrode, the projected area of the gate line, and the projected area of the source line partially overlaps each other in each pixel, the projected areas of the pixel electrodes in the same display sub-region of the lower substrate are substantially identical, and the projected areas of the pixel electrodes in the different display sub-regions are reduced gradually along one direction.

12. The substrate of claim 11, wherein the projected areas of the pixel electrodes in the different display sub-regions are reduced gradually along the direction of to the gate lines.

13. The substrate of claim 11, wherein the projected areas of the pixel electrodes in the different display sub-regions are reduced gradually along the direction of the source lines.

14. The substrate of claim 11, wherein the projected areas of the pixel electrodes overlapped the projected areas of the source lines in the same display sub-region are substantially identical, and the projected areas of the pixel electrodes overlapped the projected areas of the source lines in the different display sub-regions are reduced gradually.

15. The substrate of claim 11, wherein the projected areas of the pixel electrodes overlapped the projected areas of the gate lines in the same display sub-region are substantially identical, and the projected areas of the pixel electrodes overlapped the projected areas of the gate lines in the different display sub-regions are reduced gradually.

16. The substrate of claim 11, further comprising a plurality of storage capacitor lines disposed below the pixel electrodes, the projected areas of the pixel electrodes partially overlapped the projected areas of the storage capacitor lines, the projected areas of the pixel electrodes overlap the projected areas of the storage capacitor lines in the same display sub-region are substantially identical, and the projected areas of the pixel electrodes overlap the projected areas of the storage capacitor lines in the different display sub-regions are reduced gradually.

17. The substrate of claim 11, further comprising a upper substrate with a common electrode disposed on the active array substrate, the common electrode located above the liquid crystal layer, the projected areas of the pixel electrodes partially overlap the projected areas of the common electrode, the projected areas of the pixel electrodes overlapped the projected areas of the common electrode in the same display sub-region are substantially identical, and the projected areas of the pixel electrodes overlapped the projected areas of the common electrode in the different display sub-regions are reduced gradually.

18. The substrate of claim 11, wherein the boundary between the display sub-regions is substantially vertical to the gate lines.

19. The substrate of claim 11, wherein the boundary between the display sub-regions is substantially vertical to the source lines.

20. The substrate of claim 11, wherein the projected areas of the display sub-regions are substantially identical.
